(19) United States
(12) Patent Application Publication
(10) Pub. No.: US 2009/0303873 A1
(43) Pub. Date: Dec. 10, 2009

(54) Data transmitting apparatus

(75) Inventors: Klyoshi Kitamura, Fukuoka (JP); Kenichi Ishikawa, Fukuoka (JP); Shinji Takao, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/379,758

(22) Filed: Feb. 27, 2009

(30) Foreign Application Priority Data
Jun. 4, 2008 (JP) 2008-147215

(51) Int. Cl. G06F 11/00

(52) U.S. Cl. 370/217

(57) ABSTRACT

A data transmitting apparatus includes an actually-used-system package that is connected to outside via a plurality of ports and is actually transmitting data, a waiting-system package that is connected to outside via a plurality of ports and is waiting to substitute the actually-used-system package to transmit data when a failure occurs in the actually-used-system package, a switching requesting unit that switches, when a failure occurs in a port of the actually-used-system package, the port of the actually-used-system package to another port and issues to the waiting-system package a switching request indicating that switching is made to a port corresponding to a switching-target port, and a port switching unit that switches the port of the waiting-system package according to the switching request when the waiting-system package receives the switching request issued from the switching requesting unit.

### CROSS-REFERENCE TO RELATED APPLICATION(S)

This application is based upon and claims the benefit of priority of the prior Japanese Patent Application No. 2008-147215, filed on Jun. 4, 2008, the entire contents of which are incorporated herein by reference.

### FIELD

The embodiments discussed herein are directed to a data transmitting apparatus that transmits data utilizing line redundancy among apparatuses.

### BACKGROUND

Some communication systems have highly social and public natures. One such system is a communication system constituting a lifeline. In recent years, these communication systems are strongly demanded to operate under any circumstances. To meet such a demand, transmission lines and devices accommodating the lifeline are made redundant to enhance reliability of the system against failures.

One conventional, exemplary system with a redundant structure is depicted in FIG. 8. In the system depicted in FIG. 8, each of receiving apparatuses 400A and 400B has a cable-redundant structure. When failure occurs in a data receiving unit, the receiving apparatus switches from one cable to a redundant cable (see Japanese Laid-open Patent Publication No. 11-327941).

Specifically, each of the receiving apparatuses 400A and 400B detects a failure occurring at a data receiving unit of its own apparatus individually and, when a failure occurs, switches the cable.

Meanwhile, in the conventional technology, each receiving apparatus individually detects a failure occurring at the data receiving unit of its own apparatus and, when a failure occurs, switches the cable of only its own apparatus. Therefore, as depicted in FIG. 9, each apparatus individually detects an abnormality to switch the cable. As a result, selected ports of the apparatuses do not match each other, disadvantageously causing an instantaneous interruption of data when the connection is switched from the apparatus 400A to the apparatus 400B.

### SUMMARY

According to one aspect of the present invention, a data transmitting apparatus includes an actually-used-system package that is connected to outside via a plurality of ports and is actually transmitting data, a waiting-system package that is connected to outside via a plurality of ports and is waiting to substitute the actually-used-system package to transmit data when a failure occurs in the actually-used-system package, a switching requesting unit that switches, when a failure occurs in a port of the actually-used-system package, the port of the actually-used-system package to another port and issues to the waiting-system package a switching request indicating that switching is made to a port corresponding to a switching-target port, and a port switching unit that switches the port of the waiting-system package according to the switching request when the waiting-system package receives the switching request issued from the switching requesting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a block diagram of the configuration of a data transmitting apparatus according to a first embodiment;

FIG. 2 is a block diagram of the configuration of a data transmission system;

FIG. 3 is a drawing for explaining an interlocked switching controlling unit;

FIG. 4 is a drawing for explaining a switching determination logic;

FIG. 5 is a drawing for explaining a port switching process performed when a SW is inserted;

FIG. 6 is a flowchart of the process operation of the data transmitting apparatus (ACT side) according to the first embodiment;

FIG. 7 is a flowchart of the process operation of the data transmitting apparatus (non-ACT-side) according to the first embodiment;

FIG. 8 is a drawing for explaining a conventional technology; and

FIG. 9 is another drawing for explaining a conventional technology.

### DESCRIPTION OF EMBODIMENT(S)

Embodiments of the data transmitting apparatus according to the present invention are explained in detail below with reference to the attached drawings.

### [a] First Embodiment

In the following, the configuration and flow of process of a data transmitting apparatus according to a first embodiment is explained in sequence, and finally, effects of the first embodiment are explained.

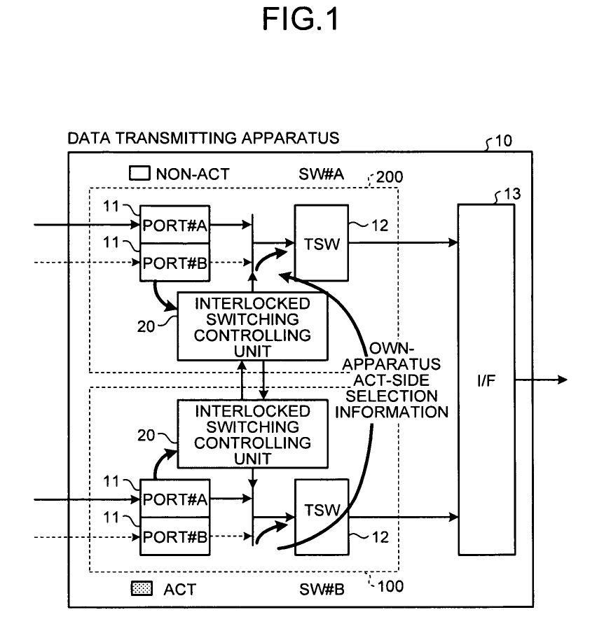

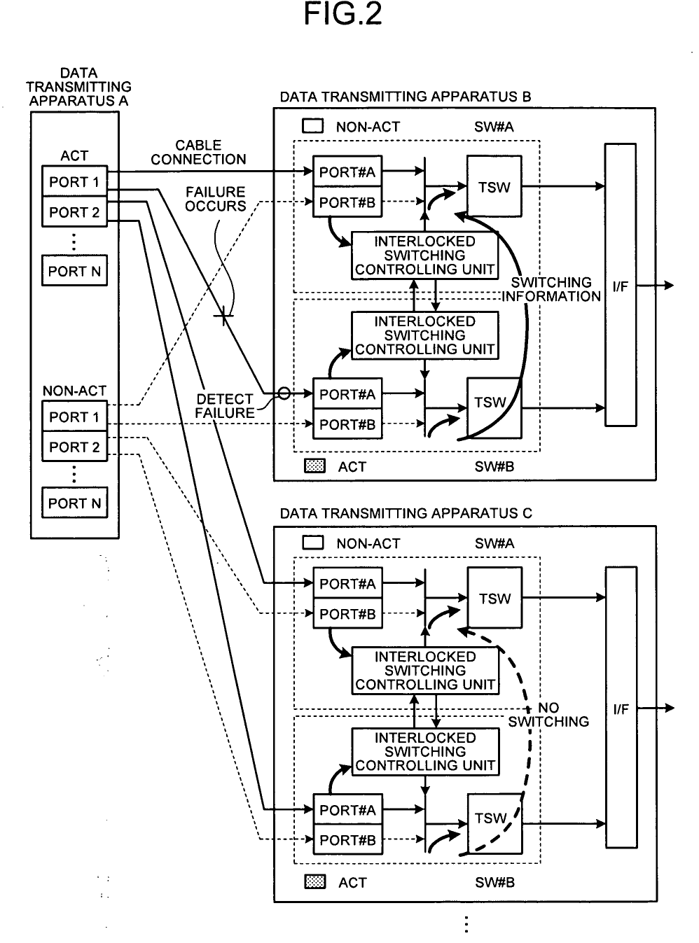

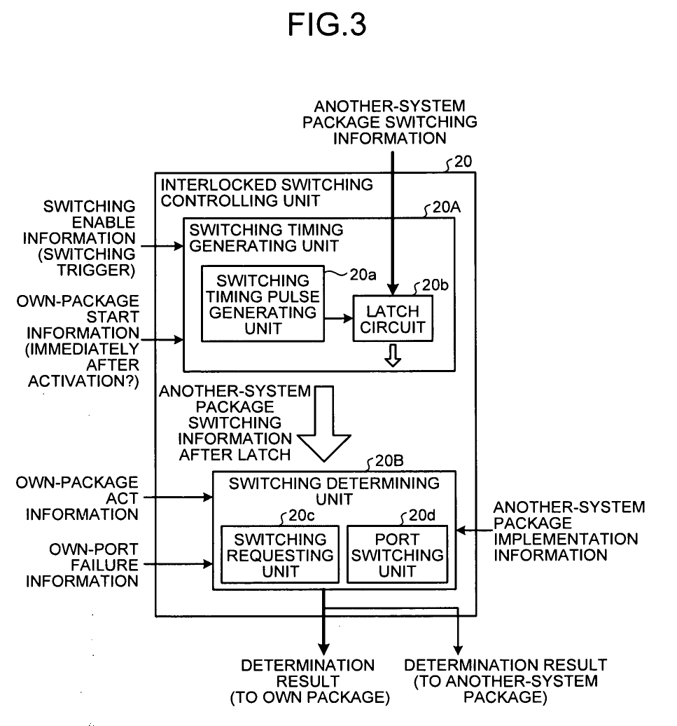

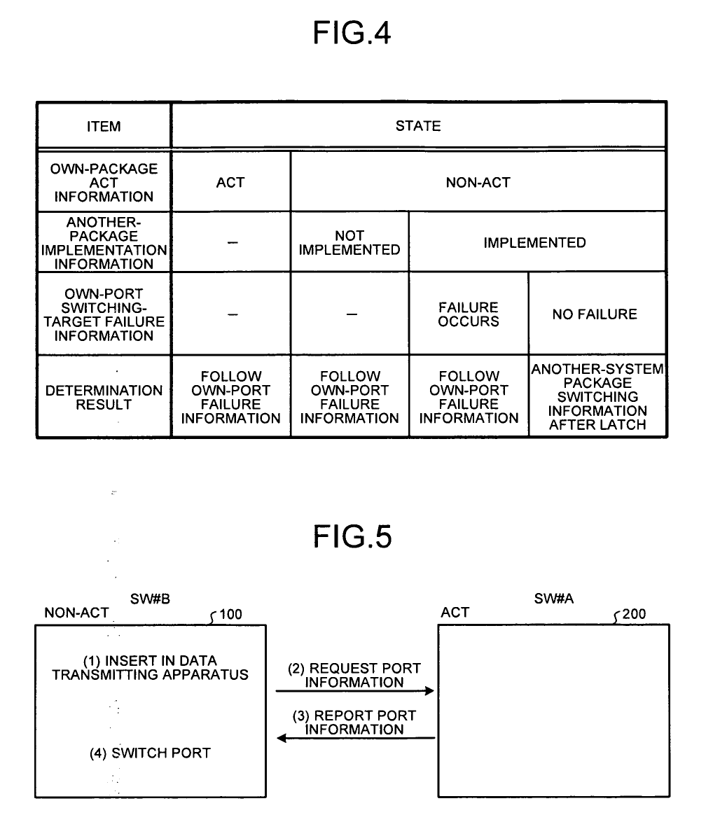

The configuration of a data transmitting apparatus 10 depicted in FIG. 1 is explained with reference to FIGS. 1 to 5. FIG. 1 is a block diagram of the configuration of the data transmitting apparatus 10 according to the first embodiment. FIG. 2 is a block diagram of the configuration of a data transmission system. FIG. 3 is a drawing for explaining an interlocked switching controlling unit. FIG. 4 is a drawing for explaining a switching determination logic. FIG. 5 is a drawing for explaining a port switching process performed when a SW is inserted.

As depicted in FIG. 1, the data transmitting apparatus 10 includes an ACT-side SW (hereinafter, referred to as an ACT-side package) 100 that is actually transmitting data, a non-ACT-side SW (hereinafter, referred to as a non-ACT-side package) 200 that is waiting to serve as an ACT-side package to transmit data when a failure occurs at the ACT-side package 100, and an interface (I/F) 13. Also, the data transmitting apparatus 10 is connected to another data transmitting apparatus via ports 11 or the I/F 13.

For example, as exemplarily depicted in FIG. 2, in a data transmission system in which a plurality of data transmitting apparatuses A, B, and C performs data transmission and reception, the data transmitting apparatus B receives data from the upper data transmitting apparatus A via ports, and transmits data to a lower data transmitting apparatus via the I/F.

Referring back to FIG. 1, the ACT-side package 100 and the non-ACT-side package 200 each includes ports 11, a time switch (TSW) 12, and an interlocked switching controlling unit 20. In the following, the process of each of these components is explained.

Each port 11 receives data from an upper data transmitting apparatus, and also detects a failure in its own port. When detecting a failure, the port 11 reports own-port failure information to the interlocked switching controlling unit 20. For example, when a failure occurs at a port #A, the interlocked switching controlling unit 20 switches from the port #A to another port #B.

The TSW 12 receives data output from a target port (for example, the port #A) among the ports 11 while being in a port switching state, and transmits the data to the I/F 13 at a predetermined timing.

The interlocked switching controlling unit 20 performs different processes depending on whether its own package is on an ACT side or non-ACT side. When its own package is the ACT-side package 100 and a failure occurs at a port (for example, the port #A), the interlocked switching controlling unit 20 switches from the port of the ACT-side package to another port thereof (for example, the port #B). Then, the interlocked switching controlling unit 20 reports to the non-ACT-side package 200 a switching request to switch to a port corresponding to the switching-target port (a port #B of the non-ACT-side package 200).

When its own package is the non-ACT-side package 200 and a switching request is received from the ACT-side package 100, the interlocked switching controlling unit 20 switches the port according to the switching request (for example, switches from the port #A to the port #B).

Here, the configuration of the interlocked switching controlling unit 20 is explained in detail with reference to FIG. 3. As depicted in FIG. 3, the interlocked switching controlling unit 20 includes a switching timing generating unit 20A for capturing switching information of another-system package and a switching determining unit 20B.

The switching timing generating unit 20A includes a switching timing pulse generating unit 20a and a latch circuit 20b. The switching timing pulse generating unit 20a generates a timing pulse for reporting to the latch circuit 20b. Specifically, the switching timing pulse generating unit 20a receives switching enable information and own-package start information, and also generates a timing pulse for capturing switching information of another-system package for reporting to the latch circuit 20b.

The latch circuit 20b is a circuit that retains the switching information reported from another-system package. Specifically, the latch circuit 20b obtains a timing pulse from the switching timing pulse generating unit 20a, and captures switching information of another-system package according to the timing of the obtained timing pulse. After latching the captured switching information of the another-system package, the latch circuit 20b reports the switching information of the another-system package to the switching determining unit 20B.

The switching determining unit 20B includes a switching requesting unit 20c and a port switching unit 20d. Also, the switching determining unit 20B receives another-system package switching information from the switching timing generating unit 20A. Also, the switching determining unit 20B receives own-package ACT information indicative of whether its own package is on an ACT side or a non-ACT side from its own package or its own port, and also receives own-port failure information indicative of the occurrence of a failure at its own port. Also, the switching determining unit 20B receives from another-system package, another-system package implementation information indicative of whether another-system package has been implemented.

Then, based on a switching determination logic, the switching determining unit 20B performs a port switching determination process. Here, the switching determination logic is a logic, as depicted in FIG. 4, for extracting as a determination result whether to perform normal port switching according to the own-port failure information or port switching according to another-system package switching information.

Specifically, when it is determined from the own-package ACT information that its own package is “ACT”, the switching determining unit 20B performs normal port switching according to the own-port failure information. On the other hand, when it is determined from the own-package ACT information that its own package is “non-ACT” and another-package implementation information indicates that other packages are “not implemented”, the switching determining unit 20B performs port switching not according to the switching information of any other packages but according to the own-port failure information.

When it is determined from the own-package ACT information that its own package is “non-ACT” and it is determined from own-port switching-target failure information that a failure occurs at the switching-target port, the switching determining unit 20B performs port switching not according to the switching information of any other-system packages but according to the own-port failure information.

Furthermore, when it is determined from the own-package ACT information that its own package is “non-ACT”, another package is implemented, and a failure does not occur at the switching-target port, the switching determining unit 20B switches the port according to another-system package switching information after latch so that its own package becomes similar to the ACT-side package 100.

When its own package is the ACT-side package 100 and a failure occurs at a port (for example, the port #A), the switching requesting unit 20c switches the port of the ACT-side package to another port thereof (for example, the port #B). Then, the switching requesting unit 20c reports to the non-ACT-side package 200 a switching request to switch to a port corresponding to the switching-target port (the port #B of the non-ACT-side package 200).

Specifically, when a failure is detected at its own port 11 and own-port failure information is received, the switching requesting unit 20c switches its own port to another port. For example, when a failure is detected at the port #A of the ACT-side package 100, switching is made from the port #A of the ACT-side package 100 to the port #B thereof.

Then, the switching requesting unit 20c reports to the non-ACT-side package 20d a switching request for the non-ACT-side package 200 to switch to a port corresponding to the switching-target port.

Then, when its own package is the non-ACT-side package 200 and a switching request is received from the ACT-side package 100, the port switching unit 20d switches the port according to the switching request (for example, switches from the port #A to the port #B).

Specifically, upon reception of a switching request from the ACT-side package 100, the port switching unit 20d determines whether switching is enabled from outside. Switching may be disabled due to maintenance, for example, or switching may be enabled through a specification by a user (for example, switching is set to be always enabled).

As a result, when switching is enabled from outside, the port switching unit 20d determines whether a failure has occurred at the switching-target port. As a result, when a failure has not occurred at the switching-target port, the port switching unit 20d switches the port so that its own package becomes similar to the ACT-side package 100.

Also, when switching is not enabled from outside or a failure has occurred at the switching-target port, the non-ACT-side package 200 ends the process without performing a switching process.

With this, the ACT-side package 100 and the non-ACT-side package 200 come to have the same switching state, thereby allowing switching between the ACT side and the non-ACT side without an instantaneous interruption of data. For example, when the ACT-side package 100 is removed due to maintenance, the non-ACT-side package 200 is switched to the ACT side, but no instantaneous interruption of data occurs.

Meanwhile, when the removed package is again inserted as the package 100 after maintenance, the data transmitting apparatus 10 performs a switching process of causing the package 100 to be on the non-ACT side to have the same switching state as that of the ACT-side package 200. This switching process is specifically explained with reference to FIG. 5.

As depicted in FIG. 5, when the non-ACT-side package 100 is again inserted after maintenance (see (1) of FIG. 5), port information is requested of the ACT-side package 200 (see (2) of FIG. 5). Then, upon reception of the request, the ACT-side package 200 reports to the non-ACT-side package 100 information about the port currently in use (see (3) of FIG. 5). Then, the non-ACT-side package 100 switches the port so as to come to have the same switching state as that of the ACT-side package 200 according to the received port information (see (4) of FIG. 5).

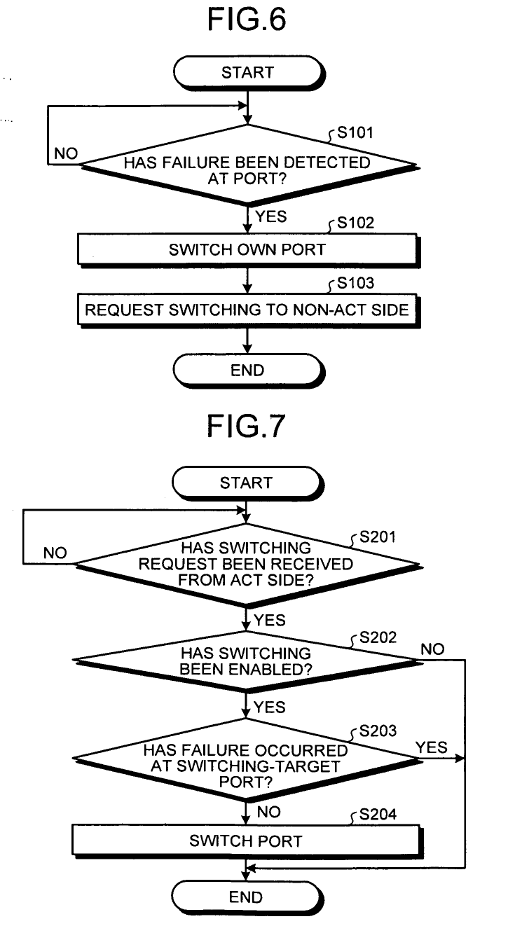

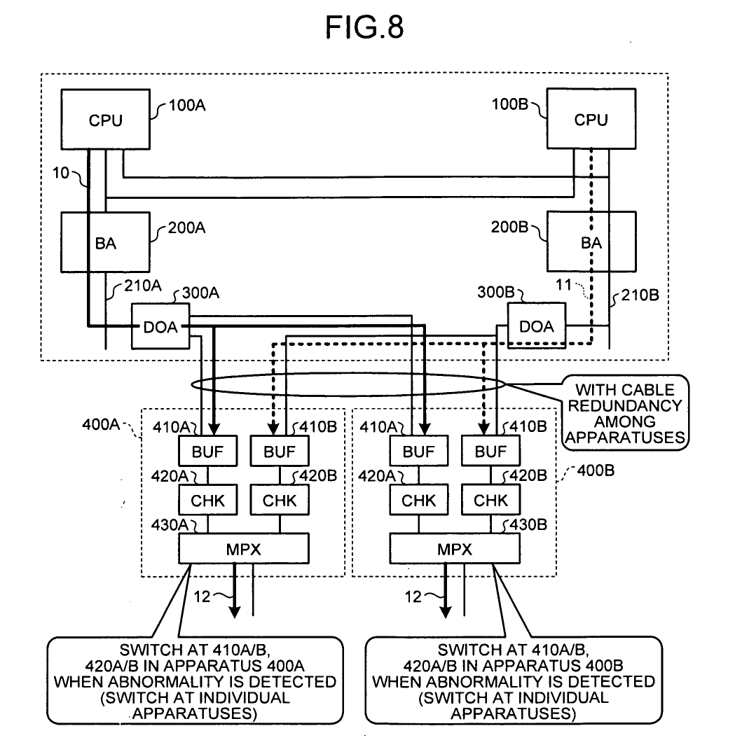

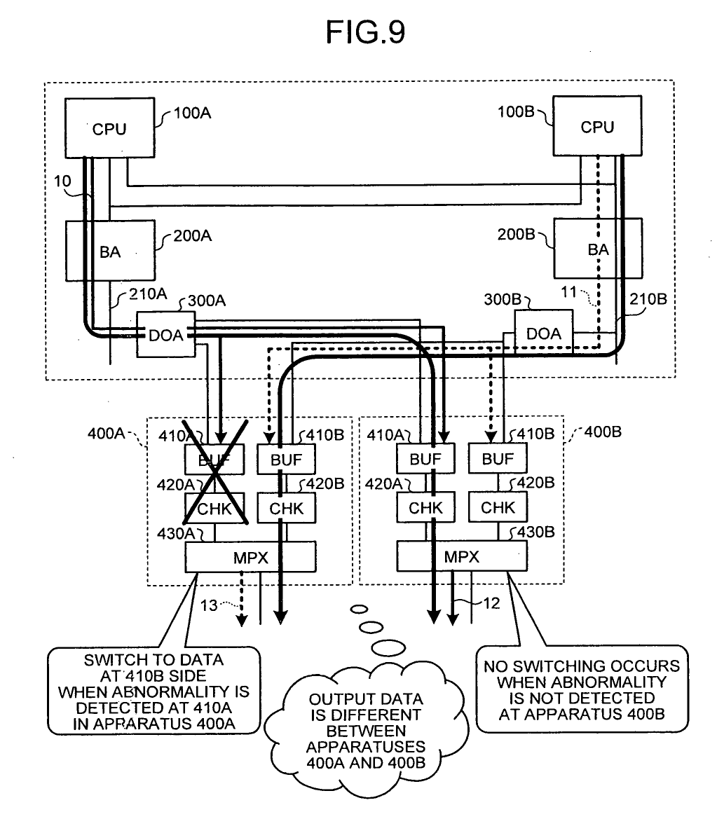

Next, the process by the data transmitting apparatus 10 according to the first embodiment is explained with reference to FIGS. 6 and 7. FIG. 6 is a flowchart of the process operation of the data transmitting apparatus (ACT side) according to the first embodiment. FIG. 7 is a flowchart of the process operation of the data transmitting apparatus (non-ACT-side) according to the first embodiment.

As depicted in FIG. 6, when detecting a failure at its own port 11 (“Yes” at step S101), the ACT-side package 100 of the data transmitting apparatus 10 switches its own port to another port (step S102). For example, when detecting a failure at Port #A of the ACT-side package 100, switching is made from Port #A to Port #B of the ACT-side package 100.

Then, the ACT-side package 100 reports to the non-ACT-side package 200 a switching request for the non-ACT-side package 200 to switch to a port corresponding to the switching-target port (step S103).

Subsequently, the process operation of the non-ACT-side package 200 of the data transmitting apparatus 10 is explained. As depicted in FIG. 7, upon reception of the switching request from the ACT-side package 100 (step S201), the non-ACT-side package 200 determines whether switching is enabled from outside (step S202).

As a result, when switching is enabled from outside (“Yes” at step S202), the non-ACT-side package 200 determines whether a failure has occurred at the switching-target port (step S203). As a result, if a failure has not occurred at the switching-target port (“No” at step S203), the non-ACT-side package 200 switches the port similarly to the ACT-side package 100 according to the switching request (step S204).

If switching is not enabled from outside (“No” at step S202) or a failure has occurred at the switching-target port (“Yes” at step S203), the non-ACT-side package 200 ends the process without performing a switching process.

As explained above, when a failure occurs at the port of the ACT-side package, the data transmitting apparatus 10 switches the port of the ACT-side package to another port thereof, and also reports a switching request to the non-ACT-side package, thereby causing the port of the non-ACT-side package to be switched according to the switching request. Therefore, the port is switched so that the non-ACT-side package comes to have the same switching state as that of the ACT-side package. As a result, switching between the ACT system and the non-ACT system can be made without an instantaneous interruption of data for port switching.

Also, according to the first embodiment, when switching enable information enabling switching comes from outside, the data transmitting apparatus 10 switches the port of the waiting-system package. When such switching enable information does not come, the data transmitting apparatus 10 suspends the process of switching the port on the non-ACT-side package. Therefore, switching can be prevented when switching is not enabled due to maintenance, for example.

Furthermore, according to the first embodiment, when the port information of the non-ACT-side package is requested and reported by the ACT-side package to the non-ACT-side package and the reported port information is received by the non-ACT-side package, the port of the non-ACT-side package is switched according to the port information. Therefore, even when a package is again inserted after maintenance, the non-ACT-side package switches the port so as to have similar state as the ACT-side package. As a result, switching between the ACT system and the non-ACT system can be made without an instantaneous interruption of data for port switching.

### [b] Second Embodiment

While the embodiment of the present invention has been explained, the present invention may be implemented in various different embodiments other than the embodiment explained above. In the following, such other embodiments are explained as a second embodiment.

Each component of each apparatus depicted is conceptual in function, and is not necessarily physically configured as depicted. That is, the specific patterns of distribution and unification of the components are not meant to be restricted to those depicted in the drawings. All or part of the components can be functionally or physically distributed or unified in arbitrary units according to various loads and the state of use. For example, the switching timing generating unit 20A and the switching determining unit 20B may be unified together. Also, all or arbitrary part of the process functions performed in each component can be achieved by a Central Processing Unit (CPU) and a program analyzed and executed on that CPU, or can be achieved as hardware with a wired logic.

Furthermore, among the processes explained in the embodiment above, all or part of the processes explained as being automatically performed may be manually performed, or all or part of the processes explained as being manually performed may be automatically performed through a known method. In addition, the process procedure, the control procedure, specific names, and information including various data and parameters can be arbitrarily changed unless otherwise specified.

An embodiment can achieve an effect of attaining switching between the actually-used system and the waiting system without an instantaneous interruption of data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A data transmitting apparatus comprising:
an actually-used-system package that is connected to outside via a plurality of ports and is actually transmitting data;
a waiting-system package that is connected to outside via a plurality of ports and is waiting to substitute the actually-used-system package to transmit data when a failure occurs in the actually-used-system package;
a switching requesting unit that switches, when a failure occurs in a port of the actually-used-system package, the port of the actually-used-system package to another port and issues to the waiting-system package a switching request indicating that switching is made to a port corresponding to a switching-target port; and
a port switching unit that switches the port of the waiting-system package according to the switching request when the waiting-system package receives the switching request issued from the switching requesting unit.

2. The data transmitting apparatus according to claim 1, wherein
when switch-enable information that enables switching is not present, the port switching unit suspends switching the port of the waiting-system package.

3. The data transmitting apparatus according to claim 1, further comprising a port-information requesting unit that requests port information about the actually-used-system package when the waiting-system package is inserted, wherein
the switching requesting unit notifies the waiting-system package of the port information about the actually-used-system package requested by the port-information requesting unit, and
when the waiting-system package receives the port information notified from the switching requesting unit, the port switching unit switches the port of the waiting-system package according to the port information.

4. The data transmitting apparatus according to claim 2, further comprising a port-information requesting unit that requests port information about the actually-used-system package when the waiting-system package is inserted, wherein
the switching requesting unit notifies the waiting-system package of the port information about the actually-used-system package requested by the port-information requesting unit, and
when the waiting-system package receives the port information notified from the switching requesting unit, the port switching unit switches the port of the waiting-system package according to the port information.
